(19) United States
(12) Patent Application Publication
(10) Pub. No.: US 2013/0258954 A1
(43) Pub. Date: Oct. 3, 2013

(54) DEVICES FOR SELECTING A CHANNEL STATE INFORMATION REPORT

(71) Applicants: Ahmad KHOSHNEVIS, Portland, OR (US); Shohei YAMADA, Camas, WA (US)

(72) Inventors: Ahmad KHOSHNEVIS, Portland, OR (US); Shohei YAMADA, Camas, WA (US)

(73) Assignee: Sharp Laboratories of America, Inc., Camas, WA (US)

(21) Appl. No.: 13/550,465

(22) Filed: Jul. 16, 2012

Related U.S. Application Data
(63) Continuation-in-part of application No. 13/436,530, filed on Mar. 30, 2012.

(51) Int. Cl. H04W 24/10

(52) U.S. Cl. 370/329

(57) ABSTRACT

A User Equipment (UE) for selecting a Channel State Information (CSI) report is described. The UE includes a processor and memory in electronic communication with the processor. Executable instructions are stored in the memory. The UE generates multiple CSI reports corresponding to at least one serving cell. A group of one or more CSI reports with a same association forms a CSI report set. The UE applies a first prioritization rule to select a single CSI report for each CSI report set and drops at least one first prioritization unselected CSI report if there is an intra-set transmission scheduling collision. The UE also applies a second prioritization rule to select at least one CSI report if there is an inter-set transmission scheduling collision.

### RELATED APPLICATIONS

This application is a continuation-in-part of U.S. patent application Ser. No. 13/436,530, entitled “COLLISION RESOLUTION AMONG TRANSMISSION SCHEDULES OF UPLINK CONTROL INFORMATION (UCI),” filed on Mar. 30, 2012, which is hereby incorporated by reference herein, in its entirety.

### TECHNICAL FIELD

The present disclosure relates generally to communication systems. More specifically, the present disclosure relates to devices for selecting a channel state information report.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may utilize feedback to improve communication quality. However, known feedback procedures are limited. As illustrated by this discussion, systems and methods that improve feedback procedures may be beneficial.

### BRIEF DESCRIPTION OF THE DRAWINGS

FIG. 1 is a block diagram illustrating one configuration of one or more evolved Node Bs (eNBs) and one or more User Equipments (UEs) in which systems and methods for selecting a Channel State Information (CSI) report may be implemented;

FIG. 2 is a flow diagram illustrating one configuration of a method for selecting a CSI report;

FIG. 3 is a diagram illustrating one example of CSI report set generation;

FIG. 4 is a flow diagram illustrating a more specific configuration of a method for selecting a CSI report;

FIG. 5 is a diagram illustrating one example of selecting one or more CSI reports in accordance with alternative A;

FIG. 6 is a flow diagram illustrating another more specific configuration of a method for selecting a CSI report;

FIG. 7 is a diagram illustrating another example of selecting one or more CSI reports;

FIG. 8 is a diagram illustrating another example of selecting one or more CSI reports;

FIG. 9 illustrates various components that may be utilized in a UE;

FIG. 10 illustrates various components that may be utilized in an eNB;

FIG. 11 is a block diagram illustrating one configuration of a UE in which systems and methods for selecting a channel state information report may be implemented; and

FIG. 12 is a block diagram illustrating one configuration of an eNB.

### DETAILED DESCRIPTION

A User Equipment (UE) for selecting a Channel State Information (CSI) report is described. The UE includes a processor and memory in electronic communication with the processor. Executable instructions are stored in the memory. The UE generates multiple CSI reports corresponding to at least one serving cell. A group of one or more CSI reports with a same association forms a CSI report set. The UE applies a first prioritization rule to select a single CSI report for each CSI report set and drops at least one first prioritization unselected CSI report if there is an intra-set transmission scheduling collision between CSI reports of at least one of the CSI report sets. The UE also applies a second prioritization rule to select at least one CSI report if there is an inter-set transmission scheduling collision between CSI reports of different CSI report sets. The second prioritization rule may be applied to select multiple CSI reports if the UE is configured to select multiple CSI reports. The UE may send at least one selected CSI report and drop other CSI reports.

Multiple CSI report sets corresponding to multiple serving cells may be generated. The second prioritization rule may be applied to select at least one CSI report if there is an inter-set transmission scheduling collision. The second prioritization rule may be applied to select multiple CSI reports if the UE is configured to select multiple CSI reports.

The first prioritization rule may be based on a Physical Uplink Control Channel (PUCCH) reporting type. The second prioritization rule may be based on at least one of a group consisting of a Physical Uplink Control Channel (PUCCH) reporting type and a CSI report set index. The UE may remove a selected CSI report and apply the second prioritization rule to select a next CSI report if the UE is configured for transmission of multiple CSI reports.

Multiple CSI report sets corresponding to multiple serving cells may be generated. The UE may apply a third prioritization rule to select one CSI report if there is an inter-set transmission scheduling collision of multiple CSI reports of multiple CSI report sets of different serving cells. The UE may remove a selected CSI report and apply the third prioritization rule to select a next CSI report if the UE is configured for transmission of multiple CSI reports.

A method for selecting a CSI report by a UE is also described. The method includes generating multiple CSI reports corresponding to at least one serving cell. A group of one or more CSI reports with a same association forms a CSI report set. The method also includes applying a first prioritization rule to select a single CSI report for each CSI report set and dropping at least one first prioritization unselected CSI report if there is an intra-set transmission scheduling collision between CSI reports of at least one of the CSI report sets. The method further includes applying a second prioritization rule to select at least one CSI report if there is an inter-set transmission scheduling collision between CSI reports of different CSI report sets.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10 and/or 11, Institute of Electrical and Electronics Engineers (IEEE) 802.16, WiMax, etc.). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an eNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a PDSCH. “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed herein provide approaches for selecting and ordering multiple channel state reports. For example, the systems and methods disclosed herein may provide algorithms for selecting and ordering multiple channel state reports. In Releases 8-10 of 3GPP specifications, only one Channel State Information (CSI) report is transmitted at any given subframe. As a result, if multiple CSI reports are scheduled to be transmitted in a given subframe, 3GPP TS 36.213 for Releases 8-10 describes procedures for selecting one CSI report.

For Release 11, multiple CSI reports may be transmitted in one subframe. However, known procedures do not specify how multiple CSI reports may be selected. The systems and methods disclosed herein provide approaches for selecting multiple CSI reports when transmission of multiple CSI reports is configured. For example, the systems and methods disclosed herein may provide a cell-agnostic CSI report set, which may include one or more CSI reports. Additionally or alternatively, the systems and methods disclosed herein provide omission and iteration in procedures for selection of a single CSI report, in order to select multiple CSI reports from a multitude of co-scheduled CSI reports, for example.

In accordance with the systems and methods disclosed herein, a UE may be configured with multiple CSI report sets corresponding to at least one serving cell. In case of a collision in scheduling transmission of multiple CSI reports of the same CSI report set, a first prioritization rule may be applied to select a single CSI report for each CSI report set and to drop the unselected CSI reports. In case of a collision in scheduling transmission of multiple CSI reports of different CSI report sets, a second prioritization rule may be applied to select at least one CSI report. A CSI report set may be a set of one or more CSI reports corresponding to the same one or more non-zero power (NZP) Channel State Information—Reference Signal (CSI-RS) resources and the same one or more interference parts. A CSI process may be an association of the same one or more channel parts (e.g., one NZP CSI-RS resource) and the same one or more interference parts. The CSI report set may be a set of one or more CSI reports generated by the CSI process. Therefore, a prioritization among multiple CSI reports of multiple CSI report sets may be referred to as a prioritization among multiple CSI reports of multiple CSI processes. A prioritization among multiple CSI reports of a CSI report set may be referred to as a prioritization among multiple CSI reports of a CSI process.

Examples of CSI reports are presented in Table (1) below. The content of each CSI report may be identified by a reporting type. In Table (1), for example, a CSI report of PUCCH reporting type 1 includes sub-band CQI.

If a UE is configured to select multiple CSI reports, the second prioritization rule may be applied to select multiple CSI reports. The UE may send the selected CSI reports and may drop other CSI reports. If the UE is configured with multiple serving cells and in case of a collision in scheduling transmission of multiple CSI reports of different CSI report sets, the second prioritization rule may be applied to select at least one CSI report. If it is configured, the second prioritization rule may select more than one CSI report.

If the UE is configured with multiple serving cells and in case of a collision in scheduling transmission of multiple CSI reports of multiple CSI report sets of different serving cells, a third prioritization rule may be applied to select a single CSI report. If the UE is configured for transmission of more than one CSI report, the UE may remove the selected CSI report and apply the third prioritization rule to select the next CSI report. If the UE is configured for transmission of more than one CSI report, the UE may remove the selected CSI report and apply the second prioritization rule to select the next CSI report.

3GPP Release 10 specifications provide a prioritization mechanism, which is given as follows. Table (1) illustrates several Physical Uplink Control Channel (PUCCH) reporting types with corresponding kinds of reported information. Depending on the PUCCH reporting type, for example, one or more of a Channel Quality Indicator (CQI), Precoding Matrix Indicator (PMI), Rank Indicator (RI) and Precoding Type Indicator (PTI) may be reported.

TABLE 1

| PUCCH Reporting Type | Reported |
|---|---|
| 1 | Sub-band CQI |
| 1a | Sub-band CQI/second PMI |
| 2 | Wideband CQI/PMI |
| 2a | Wideband first PMI |
| 2b | Wideband CQI/second PMI |
| 2c | Wideband CQI/first PMI/second PMI |
| 3 | RI |
| 4 | Wideband CQI |
| 5 | RI/first PMI |
| 6 | RI/PTI |

In case of collision of a CSI report with PUCCH reporting type 3, 5, or 6 of one serving cell with a CSI report with PUCCH reporting type 1, 1a, 2, 2a, 2b, 2c, or 4 of the same serving cell the latter CSI report with PUCCH reporting type (1, 1a, 2, 2a, 2b, 2c, or 4) has lower priority and is dropped.

If the UE is configured with more than one serving cell, the UE transmits a CSI report of only one serving cell in any given subframe. For a given subframe, in case of collision of a CSI report with PUCCH reporting type 3, 5, 6, or 2a of one serving cell with a CSI report with PUCCH reporting type 1, 1a, 2, 2b, 2c, or 4 of another serving cell, the latter CSI with PUCCH reporting type (1, 1a, 2, 2b, 2c, or 4) has lower priority and is dropped. For a given subframe, in case of collision of CSI report with PUCCH reporting type 2, 2b, 2c, or 4 of one serving cell with CSI report with PUCCH reporting type 1 or 1a of another serving cell, the latter CSI report with PUCCH reporting type 1, or 1a has lower priority and is dropped. For a given subframe, in case of collision between CSI reports of different serving cells with PUCCH reporting type of the same priority, the CSI of the serving cell with lowest ServCellIndex is reported, and CSI of all other serving cells are dropped.

Accordingly, if the UE is not configured with more than one serving cell, there is one level prioritization among multiple CSI reports of a serving cell based on PUCCH reporting type. If the UE is configured with more than one serving cell, there are two level prioritizations. In 3GPP Release 10 specifications, the first level is among multiple CSI reports of a serving cell based on PUCCH reporting type. The second level is among multiple CSI reports of multiple serving cells based on PUCCH reporting type and cell index.

In accordance with the systems and methods disclosed herein (which may be applied to 3GPP Release-11 specifications), a “CSI report set” may be defined as follows. A “CSI report set” may be a set of CSI reports corresponding to one NZP CSI-RS resource with the same interference part (which are reported on the PUCCH in different subframes and which may have different types). Thus, all the CSI reports within one “CSI report set” may correspond to a single hypothesis about the transmission scheme and interference. A CSI process may be an association of one channel part (e.g., one NZP CSI-RS resource) and one interference part. The CSI report set may be a set of one or more CSI reports generated by the CSI process. Therefore, a prioritization among multiple CSI reports of multiple CSI report sets may be referred to as a prioritization among multiple CSI reports of multiple CSI processes. A prioritization among multiple CSI reports of a CSI report set may be referred to as a prioritization among multiple CSI reports of a CSI process.

A point to point communication system may be modeled as illustrated in Equation (1).

Y=H*X+Interference+Noise (1)

In Equation (1), Y represents the received signal (at the destination, for example), H represents the channel between the sender (e.g., transmitter or source) and the destination (e.g., receiver or sink), X represents the signal transmitted from the sender, Interference represents interference caused by unwanted transmissions received at the destination and Noise represents the random additive variations to the received signal (which may be caused mostly by the circuitry at the receiver, such as thermal noise, etc., for example).

The purpose of CSI measurement is to derive characteristics of the channel, H. To measure the CSI at the receiver, a known signal, CSI-RS, is transmitted from the sender. However, the measurement at the receiver contains interference and noise, and does not accurately represent the channel, H. statistical signal processing techniques may be used for accurate estimation in the presence of noise. However, in order to compensate the effect of interference, knowledge of the interference may be needed at the receiver. Accordingly, a CSI report set may be defined as a set of one or more CSI reports corresponding to the same one or more NZP CSI-RS resources and the same one or more interference parts. A CSI process may be an association of the same one or more channel parts (e.g., one NZP CSI-RS resource) and the same one or more interference parts. The CSI report set may be a set of one or more CSI reports generated by the CSI process. Therefore, a prioritization among multiple CSI reports of multiple CSI report sets may be referred to as a prioritization among multiple CSI reports of multiple CSI processes. A prioritization among multiple CSI reports of a CSI report set may be referred to as a prioritization among multiple CSI reports of a CSI process.

The association to non-zero power CSI-RS is for performing the CSI measurement that is contaminated by noise and interference, for example. An “interference part” is a separate measurement that provides information about the interference.

In order to measure the interference, a set of resources (e.g., time and frequency resources) may be allocated in which the interference is being measured. Also, reference signals (e.g., CSI-RS) may be transmitted by interfering sources in order to perform a more accurate measurement of the interference. Hence, additional knowledge of the reference signals (such as NZP CSI-RS) used by interfering nodes may be used for measuring the “interference part” or simply interference. An Interference Measurement Resources (IMR) configuration may be a configuration that indicates resources utilized for interference measurement.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

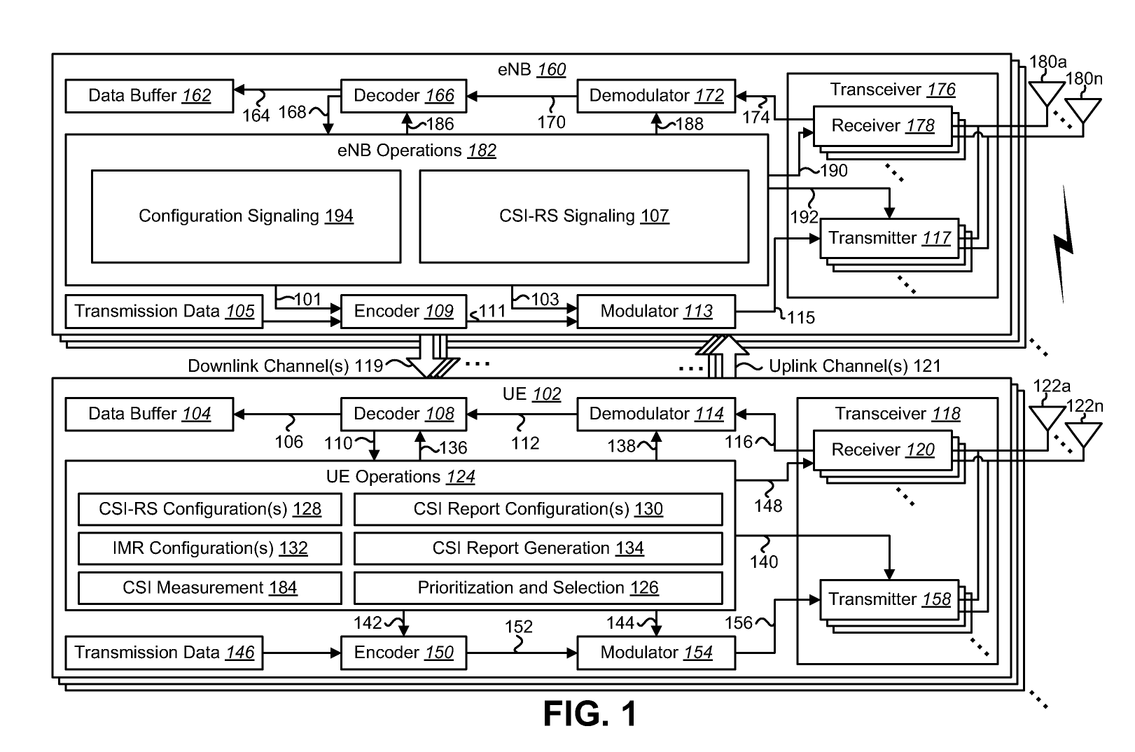

FIG. 1 is a block diagram illustrating one configuration of one or more eNBs 160 and one or more UEs 102 in which systems and methods for selecting a CSI report may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used. It should be noted that one or more geographical locations of transmission points may not necessarily be geographically collocated with the eNB 160. Also, one or more component carriers or serving cells may be used for downlink and/or uplink transmission, where each serving cell has its own communication channels.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160, transmitted from transmission points that are connected to the eNB 160 (via one or more of optical fiber, wired link and wireless link, for example), using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156. The transmitted signals may be received by receiving points that may or may not be geographically collocated with the eNB 160.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160 and/or other UEs 102 (in a device-to-device (D2D) communication, for example). The UE operations module 124 may include one or more of CSI-RS configurations 128, a one or more CSI report configurations 130, a one or more IMR configurations 132, a CSI report generation module 134, a prioritization and selection module (PSM) 126 and a CSI measurement module 184.

The UE 102 may utilize the one or more CSI-RS configurations 128 to receive and process one or more CSI-RS transmitted by the eNB 160 (where the physical layer transmission may be performed at one or more transmission points that may or may not be geographically collocated with the eNB 160 and where the higher layer transmission may be geographically collocated with the eNB 160, for example). For example, the UE 102 may receive the one or more CSI-RS configurations 128 from the eNB 160. The UE 102 may also receive one or more IMR configurations 132. The one or more IMR configurations 132 may indicate resources utilized for interference measurement, for example.

The CSI measurement module 184 may measure the one or more CSI-RS received. For example, the CSI measurement module 184 may measure the one or more CSI-RS in order to generate one or more feedback metrics (e.g., CSI measurements). The CSI report generation module 134 may generate one or more CSI reports based on the CSI measurements, the one or more IMR configurations 132 and the one or more CSI report configurations 130. For example, the CSI report generation module 134 may generate one or more CSI reports of one or more PUCCH reporting types. In turn, each PUCCH reporting type may include one or more of CQI, PMI, RI and PTI (as illustrated in Table (1) above, for example). The CSI report configuration(s) 130 may indicate PUCCH reporting type, CSI modes and/or a schedule for reporting each CSI measurement 184. The CSI report configuration(s) 130 may also indicate resources to be used for the transmission of one or more CSI reports, such as time and frequency resources.

The prioritization and selection module (PSM) 126 may prioritize and select one or more CSI reports. For example, the prioritization and selection module 126 may apply one or more prioritization rules in order to select one or more CSI reports. The application of prioritization rules is described in greater detail below. The selected CSI report(s) may be transmitted (e.g., fed back) to the eNB 160. The unselected CSI report(s) may be dropped (e.g., not transmitted). In some implementations, one or more of the elements illustrated within the UE operations module 124 may be implemented as multiple parallel modules. For example, the UE operations module 124 may include multiple PSMs 126 in some implementations.

The UE operations module 124 may provide information 148 to the one or more receivers 120. For example, the UE operations module 124 may inform the receiver(s) 120 when or when not to receive transmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include one or more (selected) CSI reports.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during an uplink (UL) subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., CSI report(s)) that may be used by the eNB operations module 182 to perform one or more operations.

In general, the eNB operations module 182 may enable the eNB 160 to communicate with the one or more UEs 102. The eNB operations module 182 may include one or more of a configuration signaling module 194 and a CSI-RS signaling module 107.

The configuration signaling module 194 may generate and send one or more configuration messages to direct UE 102 behavior. For example, the configuration signaling module 194 may generate and send one or more of the CSI-RS configuration(s) 128, IMR configuration(s) 132 and CSI report configuration(s) 130. These configurations may dictate certain functionality (e.g., modes of operation, settings, etc.).

The CSI-RS signaling module 107 may generate and send one or CSI-RS. For example, a CSI-RS may be a reference signal that the UE 102 may utilize to generate one or more CSI reports. A CSI report may provide feedback (e.g., CQI, PMI, RI, PTI) based on the communication channel.

The eNB operations module 182 may provide information 190 to the one or more receivers 178. For example, the eNB operations module 182 may inform the receiver(s) 178 when or when not to receive transmissions.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101. The other information 101 may include one or more configuration messages (e.g., CSI-RS configuration(s) 128, IMR configuration(s) 132 and CSI report configuration(s) 130).

The encoder 109 may encode transmission data 105 and/or other information 101 provided by the eNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. The one or more transmitters 117 may upconvert and transmit the modulated signal(s) 115 to one or more UEs 102. It should be noted that a downlink (DL) subframe may be transmitted from the eNB 160 to one or more UEs 102 and that an UL subframe may be transmitted from one or more UEs 102 to the eNB 160.

It should be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

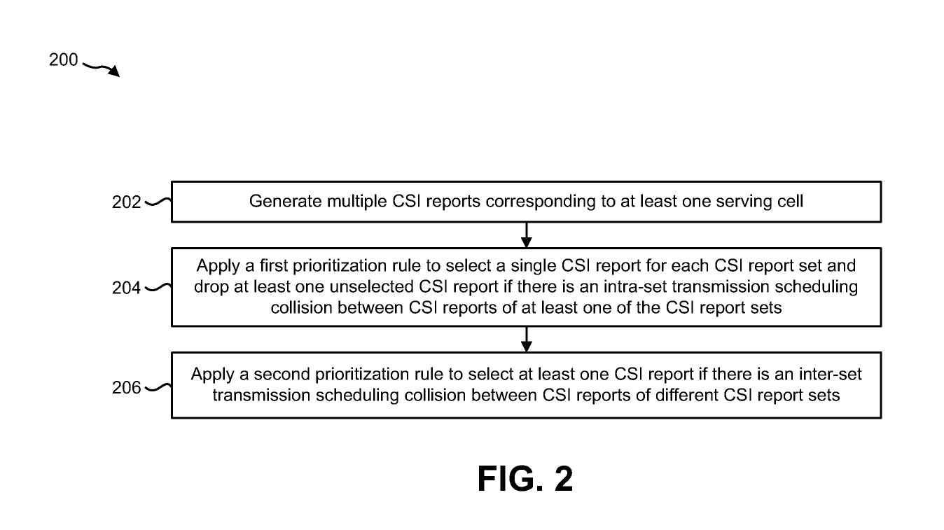

FIG. 2 is a flow diagram illustrating one configuration of a method 200 for selecting a CSI report. A UE 102 may generate 202 multiple CSI reports corresponding to at least one serving cell. A group of one or more CSI reports with the same association may form a CSI report set. A UE 102 may form a CSI report set by physically or virtually collecting CSI reports that have the same association. An example of association among CSI reports may be an association to the same set of one or more non-zero power (NZP) Channel State Information-Reference Signal (CSI-RS) resources and to a same set of one or more interference parts. Another example of association may be an association to a device to device (D2D) communication link. In some implementations, the UE 102 may additionally or alternatively generate multiple CSI report sets corresponding to at least one D2D link. Each of the CSI report sets may include one or more CSI reports corresponding to a same set of one or more NZP CSI-RS resources and to a same set of one or more interference parts. In some implementations, the UE 102 may receive a message from the eNB 160 that configures the UE 102 for generating multiple CSI report sets. It should be noted that some of the CSI reports generated by the UE 102 may belong to a device-to-device (D2D) communication, which represents a channel between different UEs 102.

The UE 102 may apply 204 a first prioritization rule to select a single CSI report for each CSI report set (or CSI process) and drop at least one first prioritization unselected CSI report if there is an intra-set (or an intra-process) transmission scheduling collision between CSI reports of at least one of the CSI report sets (or the CSI processes). For example, an intra-set (or an intra-process) transmission scheduling collision may occur if two or more CSI reports within a set (or a process) are scheduled to be transmitted in the same uplink subframe.

The first prioritization rule may be based on PUCCH reporting type. For example, CSI reports with a particular PUCCH reporting type (e.g., 3, 5 or 6) may take higher priority over CSI reports with other PUCCH reporting types (e.g., 1, 1a, 2, 2a, 2b, 2c or 4). The UE 102 may select the highest priority CSI report, while at least one first prioritization unselected CSI report (e.g., a CSI report that was not selected based on the first prioritization rule) may be dropped. Further examples of the first prioritization rule are given below.

The UE 102 may apply 206 a second prioritization rule to select at least one CSI report if there is an inter-set (or an inter-process) transmission scheduling collision between CSI reports of different CSI report sets (or CSI processes). For example, an inter-set (or an inter-process) transmission scheduling collision may occur if a first CSI report from a first CSI report set (or a first CSI process) is scheduled to be transmitted in the same uplink subframe as a second CSI report from a second CSI report set (or a second CSI process).

The second prioritization rule may be based on one or more of PUCCH reporting type and a CSI report set index. For example, CSI reports with PUCCH reporting type 3, 5, 6 or 2a may take higher priority over CSI reports with PUCCH reporting types 1, 1a, 2, 2b, 2c or 4. Furthermore, CSI reports with PUCCH reporting type 2, 2b, 2c or 4 may take priority over CSI reports with PUCCH reporting type 1 or 1a. CSI reports with the same PUCCH reporting type may be prioritized based on a CSI report set index. For example, CSI reports with higher CSI report set indexes may take priority over CSI reports with lower CSI report set indexes. The UE 102 may select one or more (e.g., N) highest priority CSI reports, while at least one second prioritization unselected CSI report (e.g., a CSI report that was not selected based on the second prioritization rule) may be dropped. Further examples of the second prioritization rule are given below.

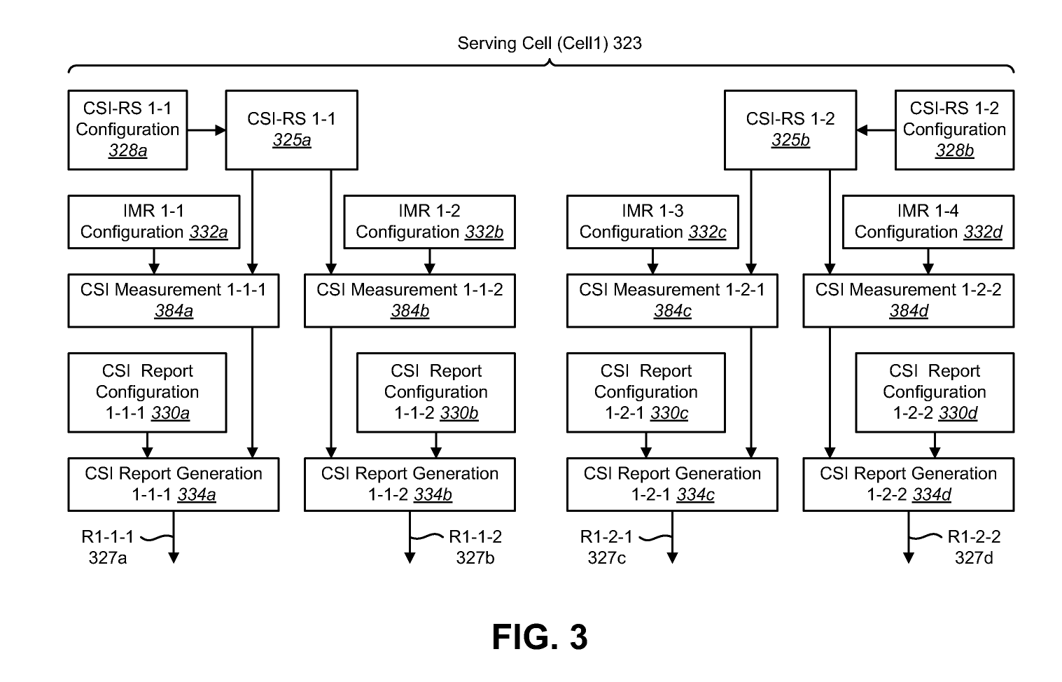

FIG. 3 is a diagram illustrating one example of CSI report set generation. A “CSI report set” may be a set of CSI reports corresponding to one NZP CSI-RS resource with the same interference part (which are reported on the PUCCH in different subframes and which may have different types as illustrated in Table (1) above, for example). Thus, all the CSI reports within one “CSI report set” may correspond to a single hypothesis about the transmission scheme and interference. FIG. 3 illustrates examples of CSI report sets, in which R1-1-1 327a is a CSI report set corresponding to CSI-RS 1-1 325a in the serving cell 323 which is indexed as Cell1. FIG. 3 also illustrates examples of other CSI report sets 327. In particular, R1-1-2 327b, R1-2-1 327c and R1-2-2 327d are examples of CSI report sets.

FIG. 3 illustrates several information and procedures that may be utilized to generate CSI report sets 327. For example, a UE 102 may receive CSI-RS 1-1 325a based on CSI-RS 1-1 configuration 328a. The UE 102 may perform CSI measurement 1-1-1 384a based on the CSI-RS 1-1 325a and an IMR 1-1 configuration 332a. The UE 102 may also perform CSI report generation 1-1-1 334a based on the CSI measurement 1-1-1 384a and a CSI report configuration 1-1-1 330a. CSI report generation 1-1-1 334a may result in a CSI report set R1-1-1 327a. As described above, for example, the CSI report set R1-1-1 327a may include one or more CSI reports, which may be of different types as illustrated in Table (1) above.

Similarly, the UE 102 may produce a CSI report set R1-1-2 327b based on the CSI-RS 1-1 configuration 328a, CSI-RS 1-1 325a, IMR 1-2 configuration 332b, CSI measurement 1-1-2 384b, CSI report configuration 1-1-2 330b and CSI report generation 1-1-2 334b. Furthermore, the UE 102 may produce a CSI report set R1-2-1 327c based on CSI-RS 1-2 configuration 328b, CSI-RS 1-2 325b, IMR 1-3 configuration 332c, CSI measurement 1-2-1 384c, CSI report configuration 1-2-1 330c and CSI report generation 1-2-1 334c and may produce a CSI report set R1-2-2 327d based on CSI-RS 1-2 configuration 328b, CSI-RS 1-2 325b, IMR 1-4 configuration 332d, CSI measurement 1-2-2 384d, CSI report configuration 1-2-2 330d and CSI report generation 1-2-2 334d.

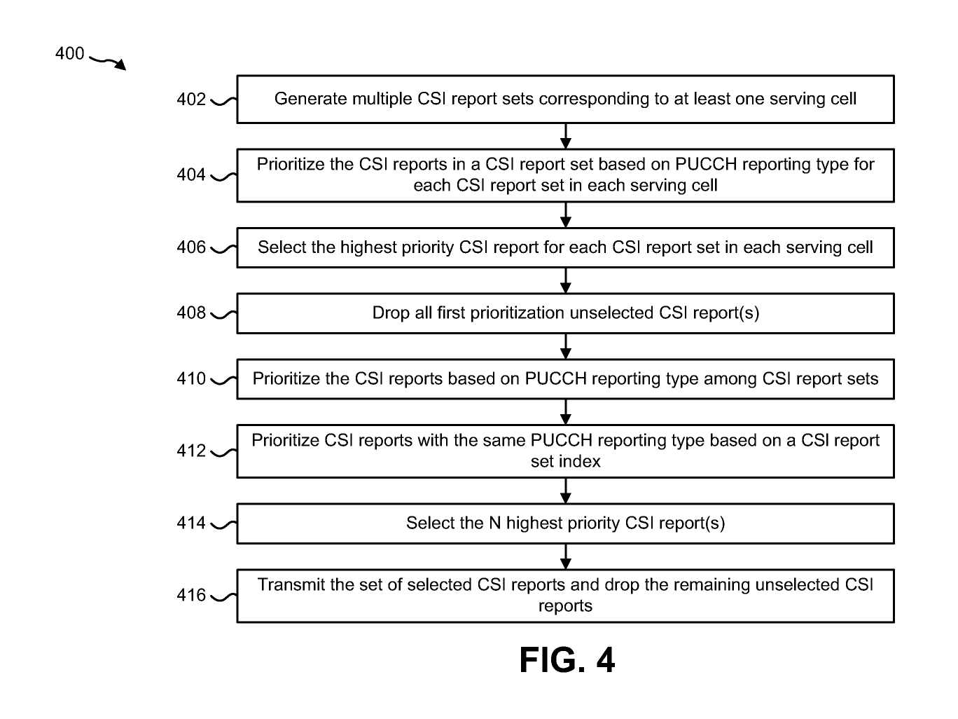

FIG. 4 is a flow diagram illustrating a more specific configuration of a method 400 for selecting a CSI report. For example, FIG. 4 illustrates a method 400 in accordance with one alternative (referred to as “alternative A” herein). Alternative A may be a simple approach for providing a cell agnostic CSI report set (per UE, for example).

A UE 102 may generate 402 multiple CSI report sets corresponding to at least one serving cell (or D2D link, for example). This may be done as described in connection with FIG. 2 above, for example. Each of the CSI report sets may include one or more CSI reports corresponding to a same set of one or more NZP CSI-RS resources and to a same set of one or more interference parts. It should be noted that CSI of a D2D link may or may not be associated with an interference part in some implementations.

If there is an intra-set transmission scheduling collision (between CSI reports of at least one of the CSI report sets), steps 404, 406 and 408 may be performed in accordance with a first prioritization rule (on a first prioritization level, for example). In particular, the UE 102 may prioritize 404 the CSI reports in a CSI report set based on PUCCH reporting type for each CSI report set in each serving cell. The UE 102 may select 406 the highest priority CSI report for each CSI report set in each serving cell. Additionally, the UE 102 may drop 408 all first prioritization unselected CSI report(s) (e.g., each CSI report that was not selected based on the first prioritization rule).

One example of the first prioritization rule is given as follows. Release 10 rules for collisions between different CSI reports may apply for coordinated multipoint (CoMP), with appropriate adaptations for the case of collision between CSI reports within one “CSI report set.” In case of collision of a CSI report with PUCCH reporting type 3, 5, or 6 of one “CSI report set” with a CSI report with a PUCCH reporting type 1, 1a, 2, 2a, 2b, 2c or 4 of the same “CSI report set,” the latter CSI report with PUCCH reporting type (1, 1a, 2, 2a, 2b, 2c or 4) has lower priority and may be dropped.

If there is an inter-set transmission scheduling collision (between CSI reports of different CSI report sets), steps 410, 412 and 414 may be performed in accordance with a second prioritization rule (on a second prioritization level, for example). In particular, the UE 102 may prioritize 410 the CSI reports based on PUCCH reporting type among CSI report sets. The UE 102 may prioritize 412 CSI reports with the same PUCCH reporting type (if any, for example) based on a CSI report set index. The UE 102 may also select 414 the N highest priority CSI report(s).

One example of the second prioritization rule is given as follows. Release 10 rules for carrier aggregation (CA) may apply for coordinated multipoint (CoMP) transmission, with appropriate adaptations for the case where multiple “CSI report sets” are configured. If the UE 102 is configured with more than one “CSI report set,” the UE 102 transmits only N highest CSI reports in any given subframe and other CSI reports with lower priority may be dropped. For a given subframe, in case of collision of a CSI report of one “CSI report set” with PUCCH reporting type 3, 5, 6 or 2a with a CSI report of another “CSI report set” with PUCCH reporting type 1, 1a, 2, 2b, 2c or 4, the latter CSI report with PUCCH reporting type (1, 1a, 2, 2b, 2c or 4) has lower priority. For a given subframe, in case of collision of a CSI report of one “CSI report set” with PUCCH reporting type 2, 2b, 2c or 4 with a CSI report of another “CSI report set” with PUCCH reporting type 1 or 1a, the latter CSI report with PUCCH reporting type 1 or 1a has lower priority. For a given subframe, in case of an intra-set collision between CSI reports of different “CSI report sets” with a PUCCH reporting type of the same priority, a CSI report with a lower CSI report set Index has lower priority.

If the UE 102 is configured to report multiple CSI reports in the same reporting instance, N>1. Otherwise, N=1. A maximum N may be fixed to two, may depend on a configuration or may depend on a maximum number of bits reached. The maximum N or maximum number of bits may be configured by an eNB 160 via Radio Resource Control (RRC) signaling in a UE-specific or cell-specific manner.

In accordance with the systems and methods disclosed herein, a CSI report set index (or process index) may be defined. In one alternative, a CSI report set index may be assigned by a higher layer across all serving cells. In another alternative, the CSI report set index=8×ServCellIndex+csiReportSetIndex, where ServCellIndex is a serving cell index, csiReportSetIndex is a report set index and csiReportSetIndex is per serving cell. In yet another alternative, the CSI report set index=ServCellIndex+8×csiReportSetIndex, where ServCellIndex is a serving cell index, csiReportSetIndex is a report set index and csiReportSetIndex is per serving cell.

The UE 102 may transmit 416 the set of selected CSI reports (e.g., one or more selected CSI reports) and drop the remaining unselected CSI reports (e.g., one or more remaining unselected CSI reports). For example, the UE 102 may transmit 416 N selected CSI reports. Any remaining unselected CSI reports may be dropped (e.g., not transmitted and possibly discarded, deleted, etc.).

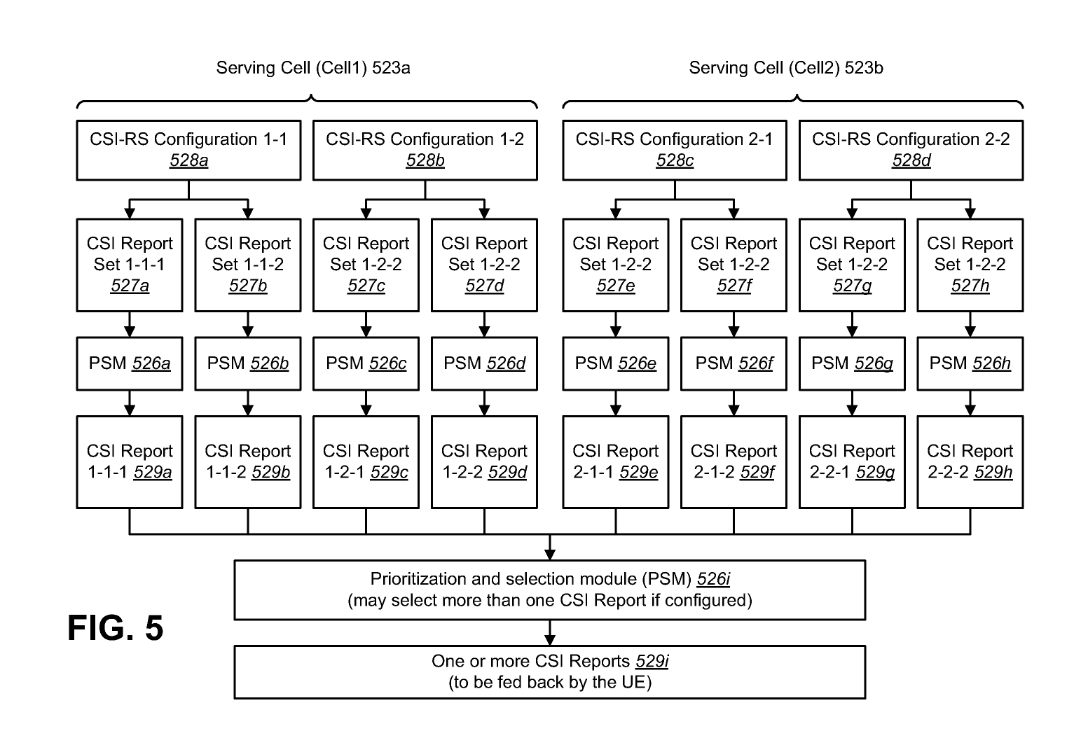

FIG. 5 is a diagram illustrating one example of selecting one or more CSI reports in accordance with alternative A. If a UE is configured with one serving cell or is configured with one CSI report set, there may be one level prioritization among multiple CSI reports of a CSI report set based on PUCCH reporting type.

The example illustrated in FIG. 5 illustrates multiple serving cells 523a-b with multiple CSI-RS configurations 528a-d. For instance, if the UE 102 is configured with more than one CSI report set 527a-h, there may be two level prioritizations. The first level may be among multiple CSI reports of a CSI report set 527 based on PUCCH reporting type. In other words, a first prioritization rule may be applied at the first prioritization level. For instance, prioritization and selection modules (PSMs) 526a-h may perform prioritization and selection of a CSI report 529 from each CSI report set 527a-h at the first level.

The second level may be among multiple CSI reports 529a-h of multiple CSI report sets 527a-h based on PUCCH reporting type and/or CSI report set index. In other words, a second prioritization rule may be applied at the second prioritization level. For instance, a prioritization and selection module 526i may perform prioritization and selection of a CSI report 529 from the CSI reports 529a-h for the serving cells 523a-b at the second level. It should be noted that multiple CSI report sets 527a-h may correspond to or may be associated with one or multiple serving cells 523a-b. If the UE 102 is configured to report multiple CSI reports in the same reporting instance, the second level prioritization may select one or more (e.g., N) CSI reports 529i as described above.

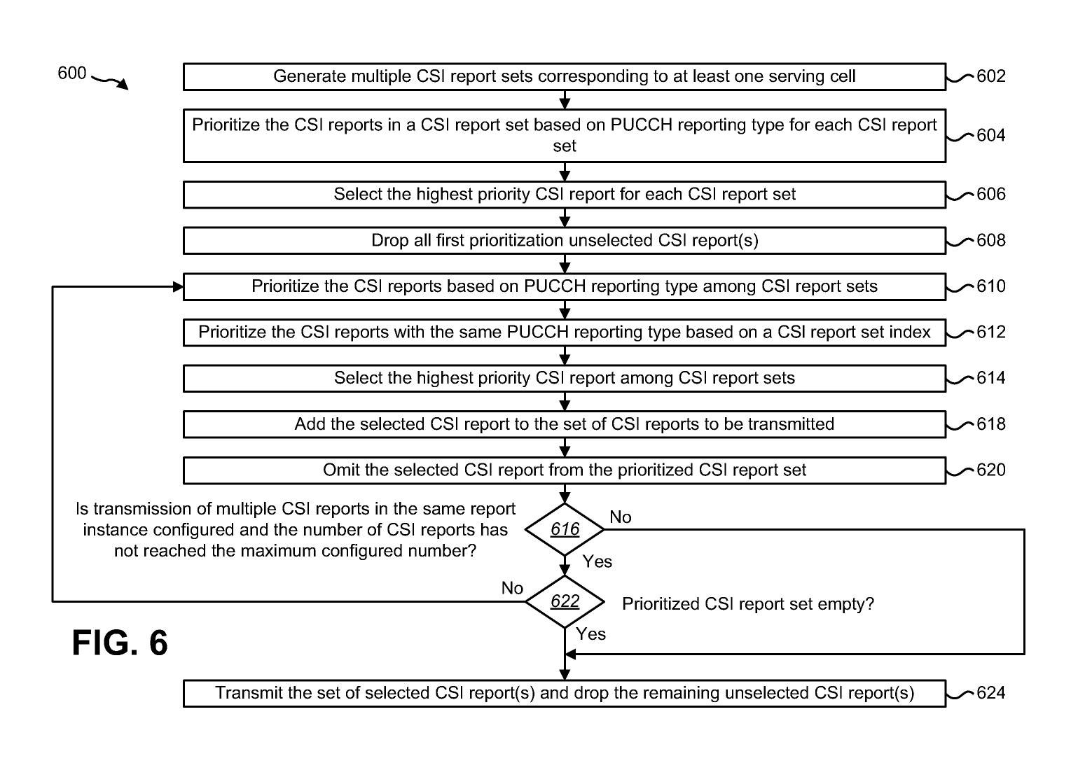

FIG. 6 is a flow diagram illustrating another more specific configuration of a method 600 for selecting a CSI report. For example, FIG. 6 illustrates a method 600 for selecting one or more CSI reports in accordance with another alternative (referred to as “alternative B” herein). In alternative B, a “CSI report set” per cell may be utilized.

A UE 102 may generate 602 multiple CSI report sets corresponding to at least one serving cell. This may be done as described in connection with FIG. 2 above, for example. Each of the CSI report sets may include one or more CSI reports corresponding to a same set of one or more NZP CSI-RS resources and to a same set of one or more interference parts.

If there is an intra-set transmission scheduling collision (between CSI reports of at least one of the CSI report sets), steps 604, 606 and 608 may be performed in accordance with a first prioritization rule (on a first prioritization level, for example). In particular, the UE 102 may prioritize 604 the CSI reports in a CSI report set based on PUCCH reporting type for each CSI report set in each serving cell. The UE 102 may select 606 the highest priority CSI report for each CSI report set in each serving cell. Additionally, the UE 102 may drop 608 all first prioritization unselected CSI report(s) (e.g., each CSI report that was not selected based on the first prioritization rule). The set of CSI reports initially resulting from selecting 606 the highest priority CSI report for each CSI report set and dropping 608 all first prioritization unselected CSI report(s) may be referred to as a “prioritized CSI report set.”

One example of the first prioritization rule is given as follows. 3GPP Release 10 rules for collisions between different CSI reports may be applied for CoMP, with appropriate adaptations for the case of collision between CSI reports within one “CSI report set.” In case of collision of a CSI report with PUCCH reporting type 3, 5 or 6 of one “CSI report set” of one serving cell with a CSI report with PUCCH reporting type 1, 1a, 2, 2a, 2b, 2c or 4 of the same “CSI report set,” the latter CSI report with PUCCH reporting type (1, 1a, 2, 2a, 2b, 2c or 4) has lower priority and may be dropped.

If there is an inter-set transmission scheduling collision (between CSI reports of different CSI report sets), steps 610, 612 and 614 may be performed. On the first iteration, steps 610, 612 and 614 may be performed in accordance with a second prioritization rule (on a second prioritization level, for example). In subsequent iterations, steps 610, 612 and 614 may be performed in accordance with subsequent rules (e.g., a third prioritization rule (on a third prioritization level, for example), a fourth prioritization rule (on a fourth prioritization level, for example), etc.). In some implementations, one or more prioritization rules may be repeatedly applied.

The UE 102 may prioritize 610 the CSI reports based on PUCCH reporting type among CSI report sets. The UE 102 may prioritize 612 CSI reports with the same PUCCH reporting type (if any, for example) based on a CSI report set index. The UE 102 may also select 614 N highest priority CSI report(s) among CSI report sets.

One example of the second prioritization rule is given as follows. 3GPP Release 10 rules for CA may apply for CoMP, with appropriate adaptations for the case where multiple “CSI report sets” are configured. If the UE 102 is configured with more than one “CSI report set” of one serving cell, the UE 102 may select or re-select a CSI report of only one “CSI report set” with highest priority in any given subframe. For a given subframe, in case of collision of a CSI report of one serving cell with PUCCH reporting type 3, 5, 6 or 2a with a CSI report of a different “CSI report set” of the same serving cell with PUCCH reporting type 1, 1a, 2, 2b, 2c or 4, the latter CSI report with PUCCH reporting type (1, 1a, 2, 2b, 2c or 4) has lower priority. For a given subframe, in case of collision of a CSI report of one serving cell with PUCCH reporting type 2, 2b, 2c or 4 with a CSI report of a different “CSI report set” of the same serving cell with PUCCH reporting type 1 or 1a, the latter CSI report with PUCCH reporting type 1 or 1a has lower priority. For a given subframe, in case of an intra-set collision between CSI reports of different “CSI report sets” with a PUCCH reporting type of the same priority, a CSI report with lower CSI report set Index has lower priority.

The UE 102 may add 618 the selected (highest priority) CSI report to a set of CSI reports to be transmitted. The UE 102 may also omit 620 (or remove) the selected CSI report from the prioritized CSI report set (that was initially generated upon selecting 606 the highest priority CSI report for each CSI report set and dropping 608 all first prioritization unselected CSI report(s), for example). In other words, the selected CSI report may be removed from entries of CSI reports and the UE 102 may reselect the next highest priority CSI report until N CSI reports are selected or no entry of CSI report exists. The maximum N may be fixed to two, may depend on the configuration or may depend on the maximum number of bits reached.

The UE 102 may determine 616 whether transmission of multiple CSI reports in the same report instance is configured and whether the number of CSI reports has not reached the maximum configured number. If the UE 102 is not configured to report multiple CSI reports in the same reporting instance, the UE 102 may transmit 624 (e.g., report) the selected CSI report and drop remaining unselected CSI report(s). For example, if the UE 102 is not configured to report multiple CSI reports, it may report only one obtained in the first prioritization or pass.

If transmission of multiple CSI reports in the same report instance is configured and the number of CSI reports has not reached the maximum configured number (e.g., N), the UE 102 may determine 622 whether the prioritized CSI report set is empty. The prioritized CSI report set may be generated (initially and upon iterating, for example) when prioritizing 610 the CSI reports based on PUCCH reporting type among CSI report sets. If no CSI reports remain in the prioritized CSI report set, the UE 102 may transmit 624 (e.g., report) the selected CSI report(s) and drop remaining unselected CSI report(s). If the prioritized CSI report set is not empty, the UE 102 may return to prioritize 610 the CSI reports based on PUCCH reporting type among CSI report sets. For example, the UE 102 may perform prioritization and selection based on one or more subsequent iterations, for example. These procedures may be followed until a set of selected CSI report(s) is transmitted 624.

It should be noted that the procedures illustrated in FIG. 5 may follow the method 600 illustrated in FIG. 6 in some implementations. In FIG. 5, there is no discrimination between the CSI reports from different serving cells. For example, CSI reports 1-1-1 to 2-2-2 529a-h are all passed to the PSM 526i. Therefore, there are two level prioritizations: one intra-set prioritization and one inter-set prioritization. Accordingly, one implementation of the PSM 526 is to select the N highest CSI reports, while another implementation is the iteration illustrated in FIG. 6.

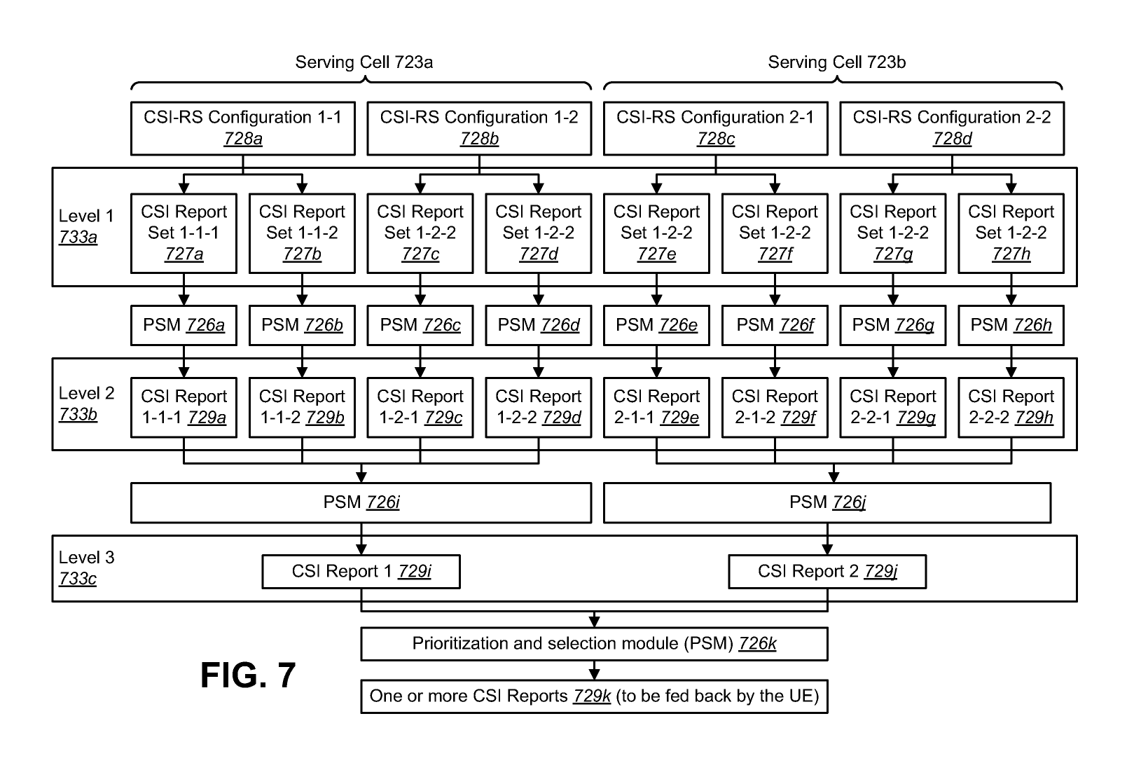

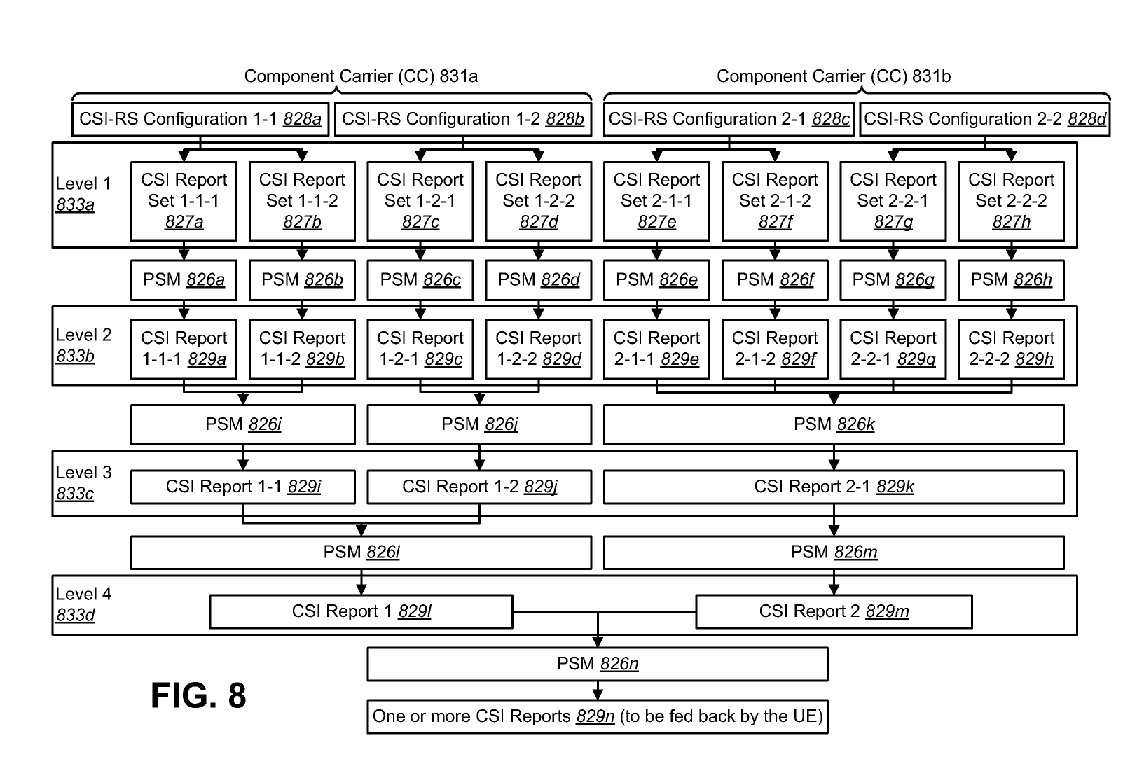

FIG. 7 and FIG. 8 are examples of procedures with omission and iteration described above (in connection with FIG. 6, for example). In FIG. 7, no distinction or prioritization is considered among CSI reports generated by NZP CSI-RS configured in the same serving cell. However, such distinction or prioritization is considered in FIG. 8.

FIG. 7 is a diagram illustrating another example of selecting one or more CSI reports. In particular, FIG. 7 illustrates an example of an iterating procedure for selecting one CSI report in order to select multiple CSI reports with no distinction between CSI-RS configured in one serving cell. If a UE is configured with one serving cell or is configured with one CSI report set, there may be one level prioritization among multiple CSI reports of a CSI report set based on PUCCH reporting type. If the UE is configured with more than one CSI report set and is configured with one serving cell, there may be two level prioritizations. The first level may be among multiple CSI reports of a CSI report set based on PUCCH reporting type. The second level may be among multiple CSI reports of multiple CSI report sets of the same serving cell based on PUCCH reporting type and/or CSI report set index.

If the UE 102 is configured to report multiple CSI reports in the same reporting instance, the selected CSI report in the second level may be removed from the set of CSI reports and the second level prioritization described above may be repeated to select the next CSI report. It should be noted that in this approach, the CSI reports from the same set may not be selected.

The example illustrated in FIG. 7 illustrates multiple serving cells 723a-b with multiple CSI-RS configurations 728a-d. If the UE 102 is configured with more than one CSI report set 727 and is configured with more than one serving cell 723, there may be three level prioritizations 733a-c, as illustrated in FIG. 7, for example. The first level 733a may be among multiple CSI reports of CSI report sets 727a-h based on PUCCH reporting type. For instance, prioritization and selection modules 726a-h may perform prioritization and selection of a CSI report 729 from each CSI report set 727a-h at the first level 733a. The second level 733b may be among multiple CSI reports 729a-h of multiple CSI report sets 727a-h of the same serving cell 723 based on PUCCH reporting type and/or CSI report set index. For instance, prioritization and selection modules 726i-j may perform prioritization and selection of a CSI report 729 from the CSI reports 729a-h for each serving cell 723a-b at the second level 733b. The third level 733c may be among multiple CSI reports 729i-j of multiple CSI report sets 727 of different serving cells 723a-b based on PUCCH reporting type and/or cell index. For instance, a prioritization and selection module 726k may perform prioritization and selection of one or more CSI reports 729k (to be fed back the UE 102, for example) at the third level 733c.

One example of a third prioritization rule is given as follows. 3GPP Release 10 rules for CA may apply for a CA case, which is described as follows. If the UE 102 is configured with more than one serving cell, the UE 102 may select or reselect a CSI report of only one serving cell with highest priority in any given subframe. For a given subframe, in case of collision of a CSI report with PUCCH reporting type 3, 5, 6 or 2a of one serving cell with a CSI report with PUCCH reporting type 1, 1a, 2, 2b, 2c or 4 of another serving cell, the latter CSI with PUCCH reporting type (1, 1a, 2, 2b, 2c or 4) has lower priority. For a given subframe, in case of collision of a CSI report with PUCCH reporting type 2, 2b, 2c or 4 of one serving cell with CSI report with PUCCH reporting type 1 or 1a of another serving cell, the latter CSI report with PUCCH reporting type 1 or 1a has lower priority. For a given subframe, in case of collision between CSI reports of different serving cells with a PUCCH reporting type of the same priority, the CSI of the serving cell with lowest ServCellIndex has lower priority.

If the UE is configured to report multiple CSI reports in the same reporting instance, the selected CSI report in the second level 733b may be removed from the set of CSI reports 729 and the second level 733b and third level 733c prioritization described above may be repeated to select the next CSI report.

Accordingly, if the UE 102 is configured with one serving cell and is configured with one CSI report set of one CSI-RS resource, there may be one level prioritization among multiple CSI reports of a CSI report set based on PUCCH reporting type. If the UE is configured with multiple CSI report sets of the same CSI-RS resource and is configured with one serving cell, there may be two level prioritizations. The first level may be among multiple CSI reports of a CSI report set based on PUCCH reporting type. The second level may be among multiple CSI reports of multiple CSI report sets of the same CSI-RS resource based on PUCCH reporting type and/or CSI report set index.

If the UE 102 is configured to report multiple CSI reports in the same reporting instance, the selected CSI report in the second level may be removed from the set of CSI reports and the second level prioritization described above may be repeated to select the next CSI report. It should be noted that in this approach, the CSI reports from the same set may not be selected.

If the UE is configured with multiple CSI report sets of multiple CSI-RS resources and is configured with one serving cell, there may be two level prioritizations. The first level may be among multiple CSI reports of a CSI report set based on PUCCH reporting type. The second level may be among multiple CSI reports of multiple CSI report sets of the same CSI-RS resource based on PUCCH reporting type and/or CSI report set index. The third level may be among multiple CSI reports of multiple CSI report sets of different CSI-RS resources of the same serving cell based on PUCCH reporting type and/or CSI-RS resource index.

If the UE 102 is configured to report multiple CSI reports in the same reporting instance, the selected CSI report in the second level may be removed from the set of CSI reports and the second and third level prioritization described above may be repeated to select the next CSI report. It should be noted that the repetition may start from third level.

FIG. 8 is a diagram illustrating another example of selecting one or more CSI reports. In particular, FIG. 8 illustrates an example of an iterating procedure for selecting one CSI report in order to select multiple CSI reports with a distinction between CSI-RS configured in one serving cell.

The example illustrated in FIG. 8 illustrates multiple component carriers 831a-b with multiple CSI-RS configurations 828a-d. If the UE 102 is configured with multiple CSI report sets 827 and is configured with multiple serving cells, there may be four level prioritizations 833a-d as illustrated in FIG. 8, for example. The first level 833a may be among multiple CSI reports 827a-h of a CSI report set 927 based on PUCCH reporting type. For instance, prioritization and selection modules 826a-h may perform prioritization and selection of a CSI report 829 from each CSI report set 827a-h at the first level 833a. The second level 833b may be among multiple CSI reports 829a-h of multiple CSI report sets 827 of the same CSI-RS resource based on PUCCH reporting type and/or CSI report set index. For instance, prioritization and selection modules 826i-k may perform prioritization and selection of one or more CSI reports 829i-k from the CSI reports 829a-h at the second level 833b. The third level 833c may be among multiple CSI reports 829i-k of multiple CSI report sets 827 of different CSI-RS resources of the same serving cell based on PUCCH reporting type and/or CSI-RS resource index. For instance, prioritization and selection modules 826l-m may perform prioritization and selection of CSI reports 829l-m from the CSI reports 829i-k at the third level 733c. The fourth level 833d may be among multiple CSI reports 829l-m of multiple CSI report sets 827 of different serving cells based on PUCCH reporting type and/or cell index. For instance, a prioritization and selection module 826n may perform prioritization and selection of one or more CSI reports 829n from the CSI reports 829l-m at the fourth level 833d (based on a fourth prioritization rule, for example).

If the UE 102 is configured to report multiple CSI reports in the same reporting instance, the selected CSI report 829n in the second level 833b may be removed from the set of CSI reports 829 and the second 833b, third 833c, and fourth 833d level prioritization described above may be repeated to select the next CSI report. It should be noted that the repetition may start from third or fourth level.

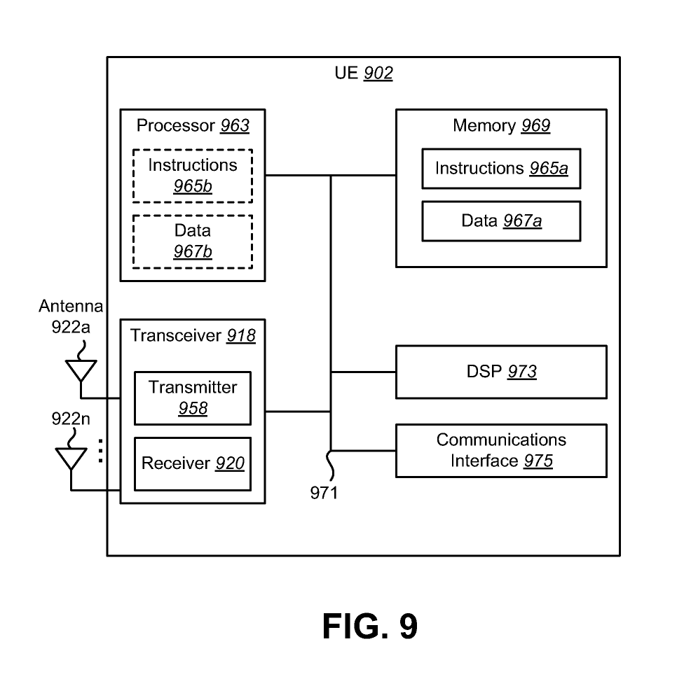

FIG. 9 illustrates various components that may be utilized in a UE 902. The UE 902 described in connection with FIG. 9 may be implemented in accordance with the UE 102 described in connection with FIG. 1. The UE 902 includes a processor 963 that controls operation of the UE 902. The processor 963 may also be referred to as a central processing unit (CPU). Memory 969, which may include read-only memory (ROM), random access memory (RAM), a combination of the two or any type of device that may store information, provides instructions 965a and data 967a to the processor 963. A portion of the memory 969 may also include non-volatile random access memory (NVRAM). Instructions 965b and data 967b may also reside in the processor 963. Instructions 965b and/or data 967b loaded into the processor 963 may also include instructions 965a and/or data 967a from memory 969 that were loaded for execution or processing by the processor 963. The instructions 965b may be executed by the processor 963 to implement one or more of the methods 200, 400, 600 described above.

The UE 902 may also include a housing that contains one or more transmitters 958 and one or more receivers 920 to allow transmission and reception of data. The transmitter(s) 958 and receiver(s) 920 may be combined into one or more transceivers 918. One or more antennas 922a-n are attached to the housing and electrically coupled to the transceiver 918.

The various components of the UE 902 are coupled together by a bus system 971, which may include a power bus, a control signal bus and a status signal bus, in addition to a data bus. However, for the sake of clarity, the various buses are illustrated in FIG. 9 as the bus system 971. The UE 902 may also include a digital signal processor (DSP) 973 for use in processing signals. The UE 902 may also include a communications interface 975 that provides user access to the functions of the UE 902. The UE 902 illustrated in FIG. 9 is a functional block diagram rather than a listing of specific components.

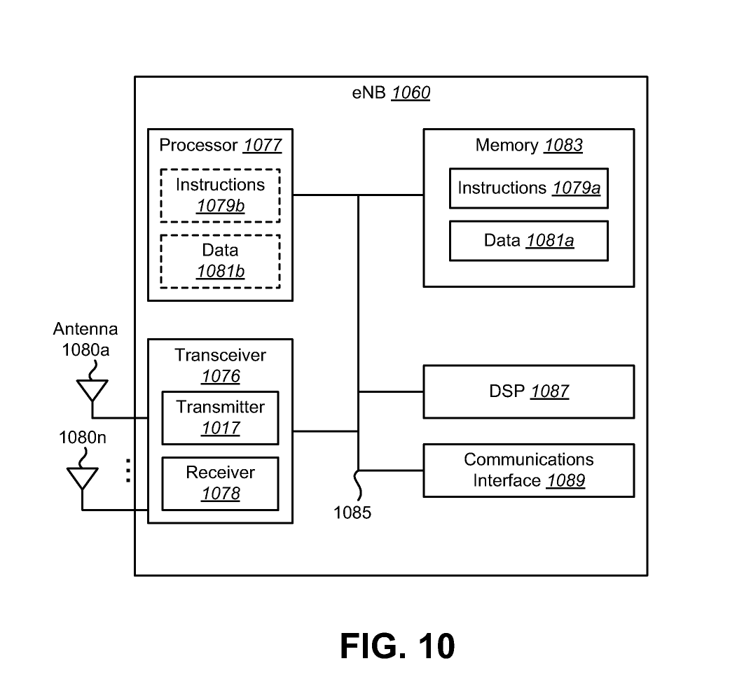

FIG. 10 illustrates various components that may be utilized in an eNB 1060. The eNB 1060 described in connection with FIG. 10 may be implemented in accordance with the eNB 160 described in connection with FIG. 1. The eNB 1060 includes a processor 1077 that controls operation of the eNB 1060. The processor 1077 may also be referred to as a central processing unit (CPU). Memory 1083, which may include read-only memory (ROM), random access memory (RAM), a combination of the two or any type of device that may store information, provides instructions 1079a and data 1081a to the processor 1077. A portion of the memory 1083 may also include non-volatile random access memory (NVRAM). Instructions 1079b and data 1081b may also reside in the processor 1077. Instructions 1079b and/or data 1081b loaded into the processor 1077 may also include instructions 1079a and/or data 1081a from memory 1083 that were loaded for execution or processing by the processor 1077.

The eNB 1060 may also include a housing that contains one or more transmitters 1017 and one or more receivers 1078 to allow transmission and reception of data. The transmitter(s) 1017 and receiver(s) 1078 may be combined into one or more transceivers 1076. One or more antennas 1080a-n are attached to the housing and electrically coupled to the transceiver 1076.

The various components of the eNB 1060 are coupled together by a bus system 1085, which may include a power bus, a control signal bus and a status signal bus, in addition to a data bus. However, for the sake of clarity, the various buses are illustrated in FIG. 10 as the bus system 1085. The eNB 1060 may also include a digital signal processor (DSP) 1087 for use in processing signals. The eNB 1060 may also include a communications interface 1089 that provides user access to the functions of the eNB 1060. The eNB 1060 illustrated in FIG. 10 is a functional block diagram rather than a listing of specific components.

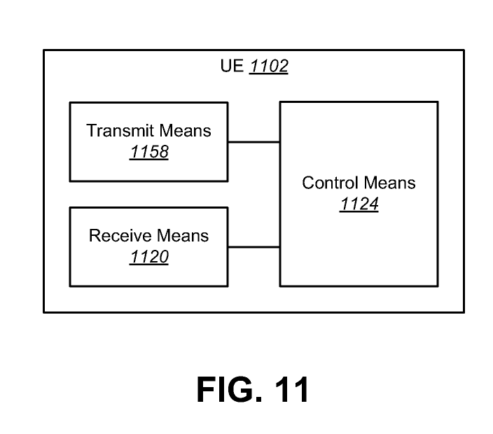

FIG. 11 is a block diagram illustrating one configuration of a UE 1102 in which systems and methods for selecting a channel state information report may be implemented. The UE 1102 includes transmit means 1158, receive means 1120 and control means 1124. The transmit means 1158, receive means 1120 and control means 1124 may be configured to perform one or more of the functions described in connection with FIG. 2, FIG. 4, FIG. 6 and FIG. 9 above. FIG. 9 above illustrates one example of a concrete apparatus structure of FIG. 11. Other various structures may be implemented to realize one or more of the functions of FIG. 2, FIG. 4, FIG. 6 and FIG. 9. For example, a DSP may be realized by software.

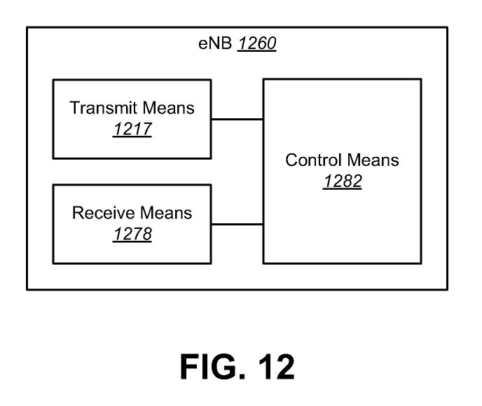

FIG. 12 is a block diagram illustrating one configuration of an eNB 1260. The eNB 1260 includes transmit means 1217, receive means 1278 and control means 1282. The transmit means 1217, receive means 1278 and control means 1282 may be configured to perform one or more of the functions described in connection with FIG. 10 above. FIG. 10 above illustrates one example of a concrete apparatus structure of FIG. 12. Other various structures may be implemented to realize one or more of the functions of FIG. 10. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A User Equipment (UE) for selecting a Channel State Information (CSI) report, comprising:
a processor;
memory in electronic communication with the processor, wherein;
instructions stored in the memory are executable to:
generate multiple CSI reports corresponding to at least one serving cell, wherein a group of one or more CSI reports with a same association forms a CSI report set;
apply a first prioritization rule to select a single CSI report for each CSI report set and drop at least one first prioritization unselected CSI report if there is an intra-set transmission scheduling collision between CSI reports of at least one of the CSI report sets; and
apply a second prioritization rule to select at least one CSI report if there is an inter-set transmission scheduling collision between CSI reports of different CSI report sets.

2. The UE of claim 1, wherein the second prioritization rule is applied to select multiple CSI reports if the UE is configured to select multiple CSI reports.

3. The UE of claim 1, wherein the instructions are further executable to send at least one selected CSI report and drop other CSI reports.

4. The UE of claim 1, wherein multiple CSI report sets corresponding to multiple serving cells are generated, and wherein the second prioritization rule is applied to select at least one CSI report if there is an inter-set transmission scheduling collision.

5. The UE of claim 4, wherein the second prioritization rule is applied to select multiple CSI reports if the UE is configured to select multiple CSI reports.

6. The UE of claim 1, wherein the first prioritization rule is based on a Physical Uplink Control Channel (PUCCH) reporting type.

7. The UE of claim 1, wherein the second prioritization rule is based on at least one of a group consisting of a Physical Uplink Control Channel (PUCCH) reporting type and a CSI report set index.

8. The UE of claim 1, wherein multiple CSI report sets corresponding to multiple serving cells are generated, and wherein the instructions are further executable to apply a third prioritization rule to select one CSI report if there is an inter-set transmission scheduling collision of multiple CSI reports of multiple CSI report sets of different serving cells.

9. The UE of claim 1, wherein the instructions are further executable to remove a selected CSI report and apply the second prioritization rule to select a next CSI report if the UE is configured for transmission of multiple CSI reports.

10. The UE of claim 8, wherein the instructions are further executable to remove a selected CSI report and apply the third prioritization rule to select a next CSI report if the UE is configured for transmission of multiple CSI reports.

11. A method for selecting a Channel State Information (CSI) report by a User Equipment (UE), comprising:
generating multiple CSI reports corresponding to at least one serving cell, wherein a group of one or more CSI reports with a same association forms a CSI report set;
applying a first prioritization rule to select a single CSI report for each CSI report set and drop at least one first prioritization unselected CSI report if there is an intra-set transmission scheduling collision between CSI reports of at least one of the CSI report sets; and
applying a second prioritization rule to select at least one CSI report if there is an inter-set transmission scheduling collision between CSI reports of different CSI report sets.

12. The method of claim 11, wherein the second prioritization rule is applied to select multiple CSI reports if the UE is configured to select multiple CSI reports.

13. The method of claim 11, further comprising sending at least one selected CSI report and dropping other CSI reports.

14. The method of claim 11, wherein multiple CSI report sets corresponding to multiple serving cells are generated, and wherein the second prioritization rule is applied to select at least one CSI report if there is an inter-set transmission scheduling collision.

15. The method of claim 14, wherein the second prioritization rule is applied to select multiple CSI reports if the UE is configured to select multiple CSI reports.

16. The method of claim 11, wherein the first prioritization rule is based on a Physical Uplink Control Channel (PUCCH) reporting type.

17. The method of claim 11, wherein the second prioritization rule is based on at least one of a group consisting of a Physical Uplink Control Channel (PUCCH) reporting type and a CSI report set index.

18. The method of claim 11, wherein multiple CSI report sets corresponding to multiple serving cells are generated, and wherein the method further comprises applying a third prioritization rule to select one CSI report if there is an inter-set transmission scheduling collision of multiple CSI reports of multiple CSI report sets of different serving cells.

19. The method of claim 11, further comprising removing a selected CSI report and applying the second prioritization rule to select a next CSI report if the UE is configured for transmission of multiple CSI reports.

20. The method of claim 18, further comprising removing a selected CSI report and applying the third prioritization rule to select a next CSI report if the UE is configured for transmission of multiple CSI reports.
